(19) United States
(12) Patent Application Publication
(10) Pub. No.: US 2024/0070691 A1
(43) Pub. Date: Feb. 29, 2024

(54) CONSUMER COMMUNICATION SYSTEM AND METHODS THEREOF

(71) Applicant: SCHNUCK MARKETS, INC., St. Louis, MO (US)

(72) Inventors: Yao XIE, St. Louis, MO (US); Thomas E. HENRY, Jr., Wildwood, MO (US); Anupriya AGRAWAL, Olivette, MO (US); Yifan ZHAO, Chesterfield, MO (US)

(21) Appl. No.: 18/229,462

(22) Filed: Aug. 2, 2023

Related U.S. Application Data
(60) Provisional application No. 63/402,232, filed on Aug. 30, 2022.

(51) Int. Cl. G06Q 30/0202

(52) U.S. Cl. CPC G06Q 30/0202

(57) ABSTRACT

Devices, systems, and methods for consumer communication can include obtaining actual product traffic data concerning consumer products, applying a mixed model to determine an incremental product traffic value, and predicting as an output of a machine learning model, impending incremental product traffic based on the incremental product traffic values, and determining a ranking of each consumer product based on the impending incremental product traffic.

### CROSS-REFERENCE

This utility application claims the benefit of priority to U.S. Provisional Patent Application No. 63/401,232, entitled “CONSUMER COMMUNICATION SYSTEM AND METHODS THEREOF,” filed on Aug. 30, 2022, the content of which is hereby incorporated by reference in its entirety.

### TECHNICAL FIELD

The present disclosure relates to devices, systems, and methods in the field of subject communication. More particularly, the present disclosure relates to devices, systems, and methods in the field of consumer communication.

### BACKGROUND

Consumer communications can involve complex issues concerning multiple variables. Rapid changes in the available information can exacerbate challenges to providing effective and/or efficient consumer communications. For large consumer-facing stores, prioritizing the manner and/or content of communications to its consumer customers can be an ongoing problem which may require balancing of specific aspects of the particular consumer products involved, but also the inventory environment particular to the communication itself. Less effective consumer communications can lead to dissatisfaction among clientele, and/or poor utilization of inventory.

### SUMMARY

According to an aspect of the present disclosure, a method of consumer communication may include obtaining actual product traffic data concerning consumer products, applying a mixed model to determine an incremental product traffic value for each consumer product based on the actual product traffic data, receiving the incremental product traffic values by a machine learning engine as inputs, and predicting, as an output of the machine learning model, impending incremental product traffic based on the incremental product traffic values, determining a ranking of each consumer product according to an assigned department based on the impending incremental product traffic, and outputting a ranked list of the consumer products based on the ranking to address the impending incremental product traffic.

In some embodiments, outputting the ranked list may include displaying a list of ranked consumer products. Outputting the ranked list may include displaying a front-page newsletter comprising a design arrangement based on the ranking. The mixed model may be a generalized linear model.

In some embodiments, each incremental product traffic value may comprise a difference between actual product transactions and an estimated baseline of transactions for each consumer product assuming exclusion from the ranked list. The estimated baseline of transactions for each consumer product may be determined based on family group. Family group may comprise a grouping of similar consumer product items sharing a brand and designated price point. In some embodiments, each family group may be assigned to a department selected from the group comprising: meat, delicatessen, general merchandizing, produce, and frozen foods.

In some embodiments, the estimated baseline of transactions for each consumer product may be determined based on seasonality. The estimated baseline of transactions for each consumer product may be determined based on seasonality and family group, if promoted during the applicable time period, and based on the effect of family group on seasonality. The estimated baseline may comprise a simulated number of transactions for each consumer product assuming that the corresponding consumer product is excluded from a front-page newsletter comprising a design arrangement based on the ranking.

In some embodiments, the method may further comprise cross-correlating the consumer products of the ranked list. Cross-correlating the consumer products of the ranked list may include determining a correlation coefficient between ranked consumer products. Cross-correlating the consumer products of the ranked list may include indicating one or more ranked consumer products for exclusion from the ranked list based on the correlation coefficients.

According to another aspect of the present disclosure, a consumer communication system may include at least one processor configured to execute instructions stored on memory to: obtain actual product traffic data concerning consumer products, apply a mixed model to determine an incremental product traffic value for each consumer product based on the actual product traffic, receive the incremental product traffic values by a machine learning engine, and predicting impending incremental product traffic based on the incremental product traffic values, determine a ranking of each consumer product according to an assigned department based on the impending incremental product traffic, and output a ranked list of the consumer products based on the ranking to address the impending incremental product traffic.

In some embodiments, configuration to output the ranked list may include displaying a list of ranked consumer products. Configuration to output the ranked list may include displaying a front-page newsletter comprising a design arrangement based on the ranking. The mixed model may be a generalized linear model.

In some embodiments, each incremental product traffic value may comprise a difference between actual product transactions and an estimated baseline of transactions for each consumer product. The estimated baseline of transactions for each consumer product may be determined based on family group. Family group may comprise a grouping of similar consumer product items sharing a brand and designated price point. Each family group may be assigned to a department selected from the group comprising: meat, delicatessen, general merchandizing, produce, and frozen foods.

In some embodiments, the estimated baseline of transactions for each consumer product may be determined based on seasonality. The estimated baseline of transactions for each consumer product may be determined based on seasonality and family group, if promoted during the applicable time period, and based on the effect of family group on seasonality. The estimated baseline may comprise a simulated number of transactions for each consumer product assuming that the corresponding consumer product is excluded from a front-page newsletter comprising a design arrangement based on the ranking.

In some embodiments, the at least one processor may be further configured to execute instructions stored on memory to cross-correlate the consumer products of the ranked list. Configuration to cross-correlate the consumer products of the ranked list may include determining a correlation coefficient between ranked consumer products. Configuration to cross-correlate the consumer products of the ranked list may include indicating one or more ranked consumer product for exclusion from the ranked list based on the correlation coefficients.

These and other features of the present disclosure will become more apparent from the following description of the illustrative embodiments.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 is a flow diagram indicating consumer communications concerning consumer products based on incremental traffic of such consumer products, according to aspects of the present disclosure;

FIG. 2 is a graphical illustration of a number of exemplary influence features for determining incremental traffic of consumer products, according to aspects of the present disclosure;

FIG. 3 is a graphic representation of exemplary incremental traffic of consumer products within a time period indicating baseline and actual consumer incremental product traffic, according to aspects of the present disclosure;

FIG. 4 is a diagrammatic view of a machine learning aspect of the present disclosure indicating that a machine learning engine can determine impending incremental product traffic based on incremental product traffic, according to aspects of the present disclosure;

FIG. 5 is a flow diagram indicating consumer communications including cross-correlation of ranked consumer products, according to aspects of the present disclosure;

FIG. 6 is a flow diagram indicating cross-correlation including valuation and threshold, according to aspects of the present disclosure;

FIG. 7 is a flow diagram indicating determination of cross-correlation including application of a cross-correlation score; and

FIG. 8 is a flow diagram indicating determination of a cross-correlation score.

### DETAILED DESCRIPTION OF THE DRAWINGS

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Consumer communications are essential to efficient operations of consumer-facing inventory stores, such as grocery stores, and/or large box retail stores. Such businesses generally offer goods (inventory) by presentation on consumer inventory shelves, but considering those with large volume of inventory, effective communications are invaluable in informing the target audience about the particulars of the inventory which have importance to the individual consumer. Yet, among a vast array of products, consumers, and related transients, distinguishing communications to effectively communicate can be a challenging task.

Additionally, the speed of change and/or volume of information can further exacerbate the challenge, rendering useful communications a constantly moving target and affording little time for actually reaching the consumer. Such issues are additionally complicated by the need to predict future events and/or conditions. Within the present disclosure, devices, systems, and methods for consumer communication can address such problems to enhance communication effectiveness.

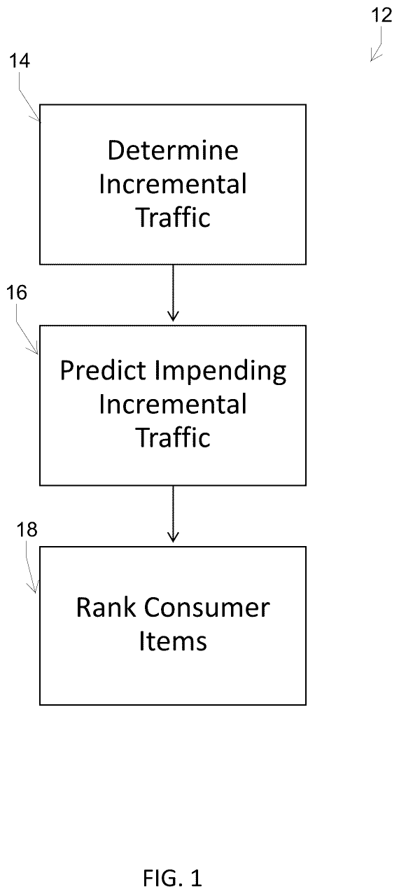

Referring to FIG. 1, a flow sequence 12 is shown concerning consumer communications according to aspects within the present disclosure. As discussed in additional detail throughout, an aspect of effective consumer communication includes selection of appropriate target subject matter for communication, including preferred consumer products. Yet, with large number of inventory products, and limited time, data, attention, and space for communications, judicious selection of the consumer products to be communicated is important. As discussed herein, preference for certain consumer products over others can be determined by ranking.

As shown in the sequence 12, a ranking of consumer products can be implemented in consideration of incremental product traffic. For example, actual product traffic of a particular consumer product can be considered in terms of sales traffic for periodic increments, (e.g., rolling weekly basis). In box 14, the actual product traffic for a particular consumer product (or group of products) can be determined. Such determinations can be made by direct examination of sales records, for example, by SKU or other identifying information, and/or may be received from third-party monitoring systems; but in some embodiments, may be estimated in terms of volume according to predetermined correlation values, for example, by sales volume according to product group, department, or store. Reliable, actual product traffic information, once obtained, can be considered for its predictive value.

In box 14, the actual product traffic information can be applied to determining incremental product traffic. In the illustrative embodiment, a mixed model can be applied to the actual product traffic information to determine an incremental product traffic value for each individual consumer product. For example, a generalized linear mixed model can be applied to account for both fixed and random effects in determining the incremental product traffic value for each consumer product.

In box 16, prediction of impending incremental product traffic can be provided based on the incremental product traffic value. In the illustrative embodiment, the incremental product traffic value for each product can be input to a machine learning model to provide prediction of impending incremental product traffic as an output of the model. Based on the incremental prediction of impending incremental product traffic, a ranking of consumer products can be determined as indicated in box 18.

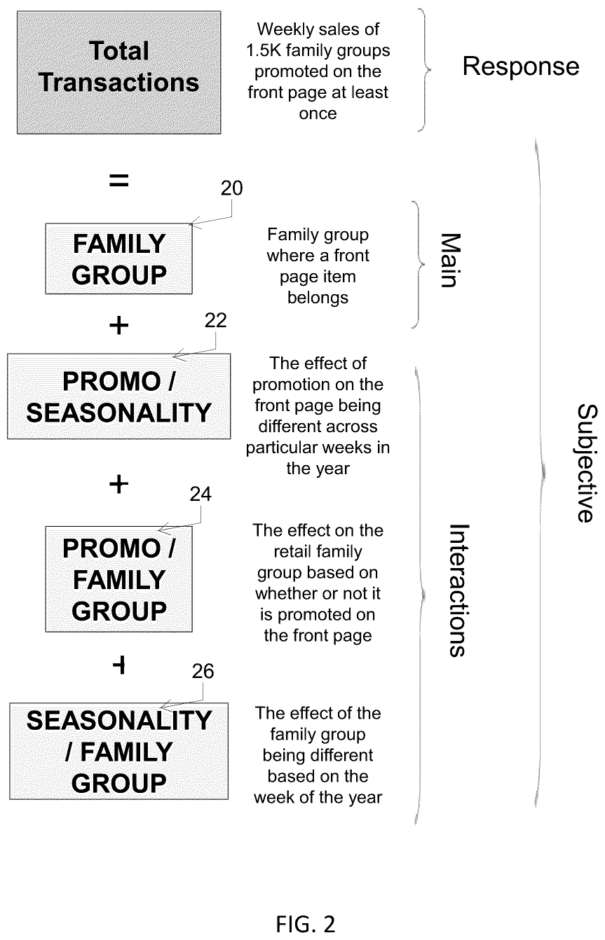

Referring now to FIG. 2, the incremental product traffic can be determined according to a number of influence features. Influence features illustratively include data driven aspects which affect the consumer product sales of the individual consumer product. For example, in the more specific example of a grocery or supermarket, consumer foods products may have considerably different impact from influence features than non-food products. In the illustrative embodiment, the influence features include family group, combined promotion and seasonality, combined promotion and family group, and combined seasonality and family group. Such combined influence features can represent interactions between the features, while individual features can represent the main effects. Particularized modeling can introduce random effects for one or more influence features. Applying a mixed model, a response can be determined as the total transactions representative.

As discussed in additional detail herein, in the illustrative embodiment, consumer products can be ranked to enhance consumer communications. Selective consideration of the consumer product rankings can determine a ranked list of consumer products for targeting to enhance consumer communications. An exemplary form of a ranked list of consumer products can include an ordered list of consumer products to be included on a front page of a consumer newsletter corresponding to the relevant time period, although in some embodiments, the ranked list may comprise the front page consumer letter itself as an output with the consumer products arranged based upon ranking.

As shown in FIG. 2, the total transactions can be represented as a response to the subjective influence features including the family group 20, combined promotion and seasonality 22, combined promotion and family group 24, and combined seasonality and family group 26. In the illustrative embodiment, the family group for a given consumer product is determined according to its field of consumption, which in the exemplary context of grocery, such family groups can include a particular brand of product, concerning a particular product at a particular price point. For example, a family group for baby food may include a particular brand, size, and/or style of baby food which corresponds to a particular price point. For explanation purposes, a family group for such baby food may be defined as Gerber® 3.0 oz jars of baby food, which can include several different styles and/or flavors of baby food, but which generally adhere to a single price point (e.g., $1.49) such that their individual sales activities are not particularly relevant to distinguish from each other. By comparison, similar products which vary enough in characteristics for designation into another family may include differently sized unit portions (e.g., 8 oz), differently packaged units (e.g., resealable bag), style (e.g., organic, lactose sensitive), and/or other distinguishing features (e.g., Disney® cross-marketing promotion) such that the price point differs (e.g., $2.29) even for otherwise similar baby food products. In some instances, the particular price point may include a range, for example, where fewer product options exist and/or for more generic products in which variation is less concerning, such that a brand of baby food within the range of about $1.49-1.99 may constitute a single family group within the baby department. Such family groups are generally defined within various departments such as meat, delicatessen, general merchandizing, produce, baby, and frozen foods departments. In some embodiments, different family groups may be applied, including fewer or greater groups and/or sub-groups. In this way, family groups define the relevant product grouping by reducing the noise which may exist for product variation within that same group that is otherwise irrelevant to distinguish the consumer product, e.g., flavor versus brand. Accordingly, family group can be likened to an individual consumer product for illustrative purposes, and for avoidance of doubt, disclosed aspects considering individual products can likewise be expressed in terms of family group, for example, incremental product traffic can refer to incremental traffic of individual consumer products but can also refer to incremental traffic of individual family groups.

In the illustrative embodiment, promotion as an influence factor is applied as a binary variable indicating whether or not an item is promoted by the given consumer communication—namely, whether the item is promoted on the front page of the consumer newsletter. For purposes of discussion, status on the front page of the consumer newspaper is considered to be a primary promotion position, and such primary promotion position can correspond to other communication techniques in other embodiments of consumer communications, for example, to be communicated with a preferred group with greater emphasis, accompanying audio, and/or accompanying information such as pictures, description, links, etc. For purposes of explanation, by comparison, a secondary promotion position may be considered promotion only within an inner page (i.e., not on the front page) of a consumer newsletter.

In the illustrative embodiment, the combined promotion and seasonality influence factor 22 indicates the effects of passing seasonal promotion. For example, during the U.S. Holiday times such as November, December, January months, individually or collectively, promotion of particular consumer products can have different effects. Stationary items, such as greeting cards may receive little promotional value, while seasonal decorations and/or seasonal foods may exhibit high promotional value during this time period. In the illustrative embodiment, this combined promotion and seasonality influence factor comprises the effect of differentiation in the consumer products during the seasonal period, as compared to other non-seasonal periods of the year. Accordingly, the combined promotion and seasonality influence factor may provide a greater contribution to the total transactions for seasonally affected consumer products having greater effectiveness of promotion in consumer communication.

The combined promotion and family group influence factor 24 indicates the effects of promotion for a given family group. In the illustrative example of front page consumer newsletter as the promotion criteria, certain family groups may exhibit greater (or lower) effect from front page status. For example, delicatessen family group consumer products may exhibit benefit from front page status, but less so than consumer products with the general merchandizing family group. Accordingly, the combined promotion and family group influence factor may provide a greater contribution to the total transactions for consumer products of family groups having greater effectiveness in promotion.

The combined seasonality and family group influence factor 26 indicates the effects of seasonality on a given family group. Certain family groups may exhibit greater (or lower) effect from seasonality. For example, delicatessen family group consumer products may exhibit greater benefits during summer holiday periods than dairy, but less so during winter holiday periods. Other examples can include, within baby foods, family groups having smaller package (e.g., 3 oz versus 8 oz jars) may exhibit greater (or lower) effect from seasonality, for example, smaller jars may be more attractive during summer months due to spoilage concerns. Accordingly, the combined seasonality and family group influence factor may provide a greater contribution to the total transactions for consumer products of family groups having greater effectiveness in promotion.

In general, the specific main and combined influence features as discussed above are illustratively represented as subjective factors having predetermined effect, for example, by multiplier value. Such subjective factors are distinct from random variables which may consider the same influence features but be applied separately, for example, as separate values to address unspecified variation.

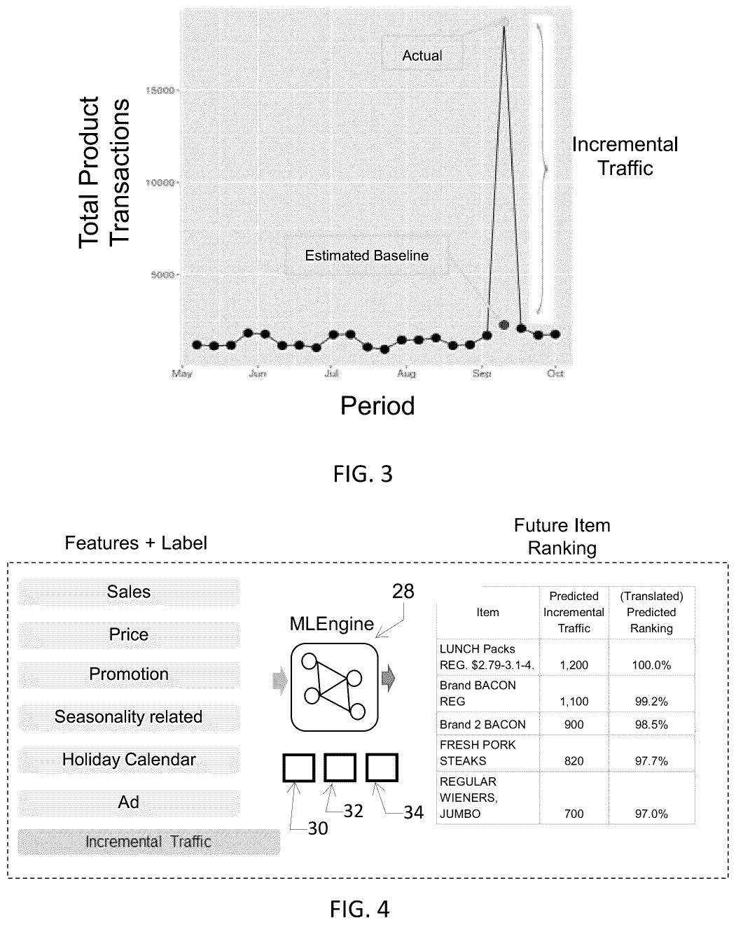

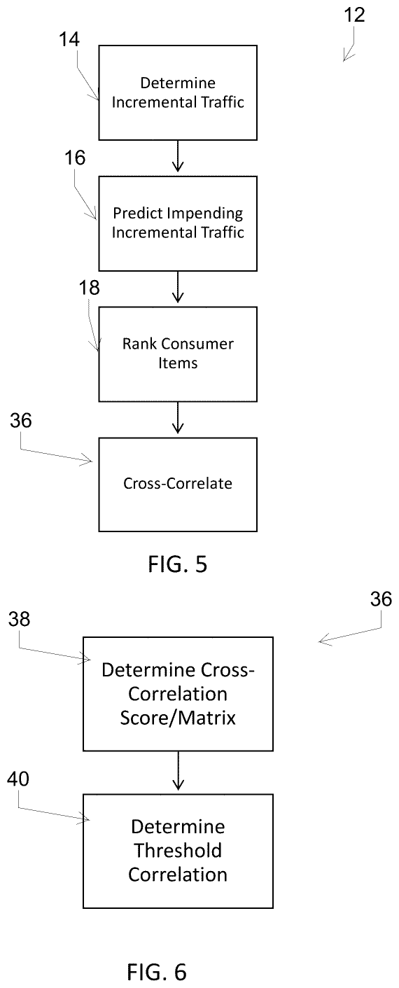

Referring now to FIG. 3, an estimated baseline can be determined as the simulated consumer product traffic assuming consumer communication excludes the particular consumer product. Again, within the exemplary front page consumer newsletter, exclusion is embodied as exclusion only from the front page. As suggested in the exemplary graphic of FIG. 3, an actual total product transactions volume can be seen having a large increase (spike) in September compared with previous (and later) transaction volume within the observed time period. In the illustrative embodiment, the product transaction totals represent the total transactions (product sales units) for a given individual product, however, in some embodiments, this may represent the total transactions for a group of products, for example, a group of products communicated together on the front page consumer newsletter. The actual total product transactions volume is shown by example to be above 15,000 transactions (e.g., about 18,000 units) in FIG. 3. By comparison in FIG. 3, an estimated baseline is shown by example to be less than 5,000 transactions (e.g., about 2,500 units) in accordance with the other data points within the observed time period.

The difference between the estimated baseline and the actual total product transactions illustratively provides an incremental product traffic. In the exemplary conditions for FIG. 3, the incremental product traffic value is about 15,500 transactions as the difference between the exemplary estimated baseline and the actual total product transactions. The incremental product traffic value, thus, can indicate the effectiveness of appropriate consumer communications in enhancing consumer communications.

Referring to FIG. 4, determining impending incremental product traffic can assist in appropriate consideration of consumer product ranking. As mentioned above, impending incremental product traffic can be determined by applying a machine learning model, embodied as machine learning engine 28, to the incremental product traffic values in consideration of appropriate influence features. The machine learning engine 28 receives the incremental product traffic values as inputs to predict the impending incremental product traffic. In the illustrative embodiment, the machine learning engine 28 receives other information as assistive influence features such as sales (in dollars), price, applicable holiday calendar, advertisement information for determining impending incremental product traffic. The influence features are illustratively predetermined, and each may be fixed or fluctuating. For example, the assistive influence feature for price of a consumer product may fluctuate, while the holiday calendar typically would remain fixed.

The machine learning engine 28 is illustratively implemented by a control system comprising processor 30, memory 32, and communications circuitry 34. The processor 30 is arranged to execute instructions stored on memory 32 and to provide governing communications via communications circuitry 34 to send/receive signals to provide control system operations. In

As suggested in FIG. 4, the machine learning engine 28 can determine a ranking of consumer products based on the impending incremental product traffic for each consumer product. In the illustrative embodiment, the ranking determination is shown by family group, illustratively indicating the meat department, for a forecast period of 13 weeks. In the illustrative embodiment, the ranking determination can include ranking of all family groups in each department. In some embodiments, product ranking may be delineated (or not) by any suitable manner according to any suitable period.

As suggested in FIG. 4, impending incremental product traffic as determined by the machine learning engine 28 can be applied directly in determining (predicted) product ranking. Notably, the exemplary product list is shown in FIG. 4 in descending order based on the impending incremental traffic volume, from 1200 units to 700 units. In some embodiments, the ranking of each consumer products may include consideration of other influence features.

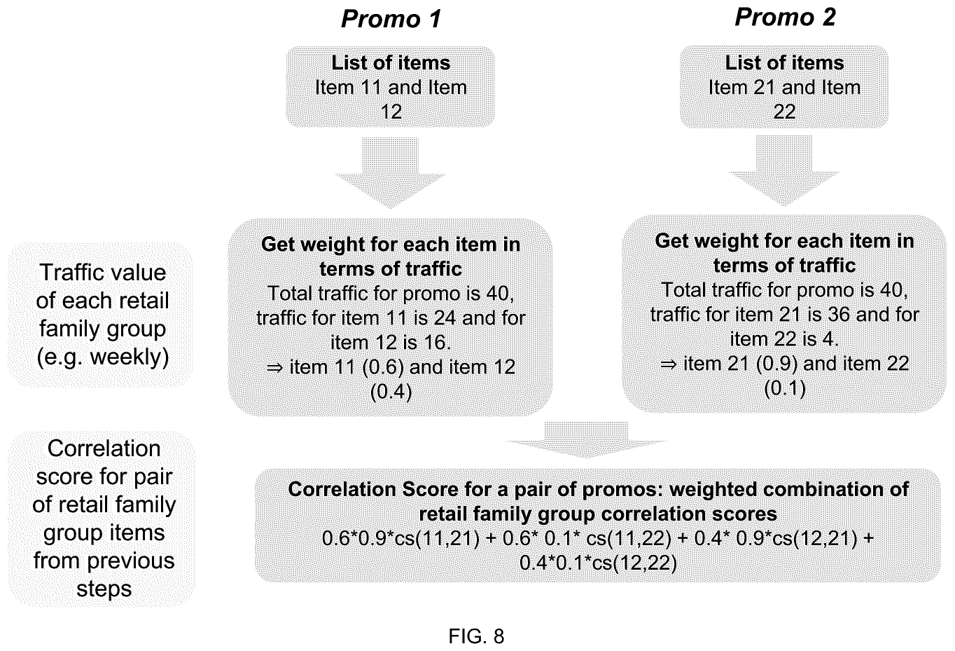

Referring now to FIG. 8, cross-correlation 36 of the ranking consumer products may be conducted. By cross-correlating the determination of product ranking, inefficiencies in consumer communications can be reduced. For example, conceptual overlap can be considered to reduce communication interference.

Communication interference can occur between specific consumer product items for a variety of reasons. For example, highly similar products promoted in close proximity (physical or temporal) can cause consumer confusion. Potential for similarity-based confusion can result from promotion of similar products by different manufacturers (brands) being promoted in close proximity to each other—one non-limiting example can include promoting different brands of shampoo which have equivalent features, quantity, and/or price. The promotion effect for each product can be significantly reduced when communicating equivalent products in close proximity causing consumer confusion.

Communication interference can occur from other correlations between consumer products. Similar appearances in coloring, branding, size, and/or use of consumer products can cause related consumer confusion. For example, consumer products from dissimilar categories may have similar color schemes or type font, such as Kellogg's® and CocaCola®, when commonly presented in white font with red background, have similar classic font styling, and may appear rather similar even though their associated consumer products (e.g., breakfast cereal vs. soft drink) may not be from particularly similar categories. Accordingly, communication interference can result from conceptual overlap whether categorical, visual, or emotional. Cross-correlation can identify and/or accommodate such sources of communication interference.

Referring now to FIG. 6, cross-correlation 36 can include determination of cross-correlation metrics 38 and determination of threshold correlation 40. In the illustrative embodiment, determination of cross-correlation metrics 38 includes determination of a cross-correlation value between consumer products of the ranking. The cross-correlation values are illustratively embodied as a score or matrix value indicating the level of strength of correlation between consumer products.

Determination of threshold correlation 40 can include determining the greatest allowable correlation value. The greatest allowable correction value may be determined based on the available correlation values from the consumer product ranking. For example, the volume of information available for a given consumer communication may be constrained by number of products or capacity of the communication, whether time-limited, dimension-limited, and/or otherwise. In the illustrative example of a front page of a consumer newsletter, the page dimension and dimensional constraints of each promotion (e.g., minimum font size) may dictate constraints on the number of consumer products which can be effectively communicated. In the illustrative embodiment, the newsletter is embodied as a printed newspaper, although in some embodiments, the newsletter may include any suitable form, including, for example, print, digital (visual, audio, interactive), among others.

Based on the available correlation values, the threshold correlation criteria can be determined. Consumer products within the ranking which exceed the cross-correlation threshold can be considered for exclusion to reduce risk of communication interference. For rankings containing more consumer products than can be accommodated in a given consumer communication, for example, more than can be presented on the front page of the consumer newsletter, lower correlation values can take precedence in determining which consumer products can be included in a final ranked list.

In the illustrative embodiment, cross-correlation 36 can be performed in conjunction with the machine learning model, for example, by communication of the consumer product rankings with another system for cross-correlation, and outputting of final ranking lists can be provided by the machine learning model based on cross-correlation by other systems or by other systems themselves. In some embodiments, the machine learning engine 28 may perform cross-correlation 36 on the consumer product rankings and may output a ranked list of consumer products for the given consumer communication. Consumer communication constraints, such as size, duration, dates for communication, may be entered into the machine learning engine as inputs for selecting the final ranked list.

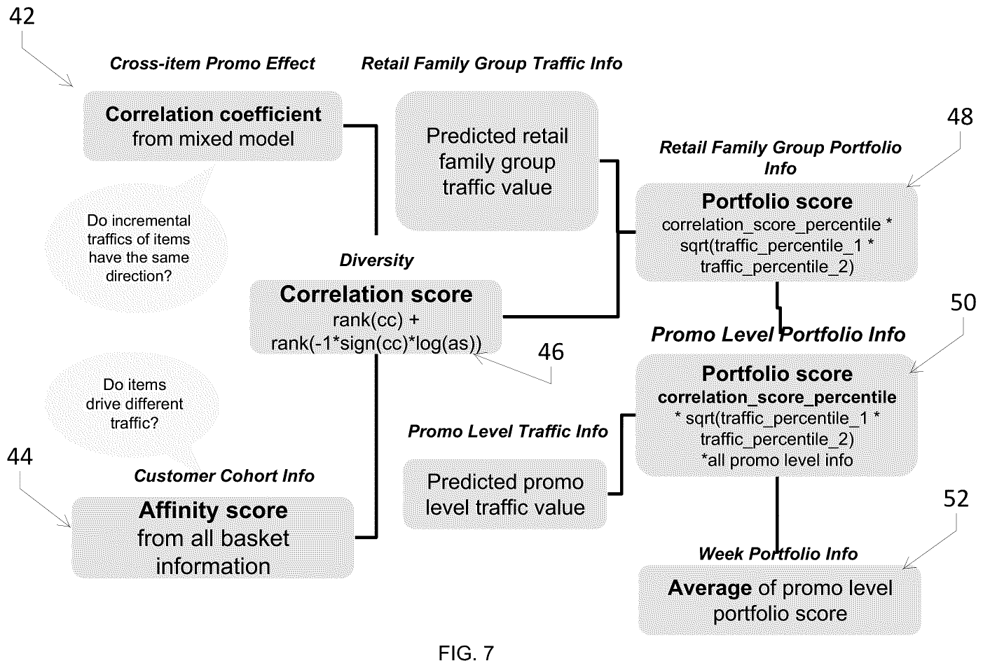

Referring to FIGS. 7 and 8, correlation between individual consumer products and/or family groups can be determined. By way of example, correlation illustratively considers transactions for the past two years, but may consider any suitable framework of transactions. In the illustrative embodiment, correlation is conducts between pairs of individual consumer products and/or individual family groups and/or between an individual consumer product and an individual family group, which for explanation purposes will collectively be referred to as consumer items. In FIG. 7, box 42, a correlation coefficient can be determined for given consumer items. The correlation coefficient is illustratively determined from the mixed model as an indication of whether the consumer items exhibit the same direction (polarity, e.g., positive/negative) of incremental product traffic. In box 44, an affinity score can be determined as an indication of whether individual consumers tend to purchase each consumer item being correlated, for example, if two consumer products are being correlated, whether both consumer products are purchased by the same consumer.

In box 46, a correlation score can be determined. The correlation score is embodied as a consideration of each of the correlation coefficient and the affinity score. The correlation score is illustratively expressed as a sum of the rank of the correlation coefficient for a given pair of consumer items and the rank of the inverse sign (polarity) of the correlation coefficient for the given pair of consumer items multiplied by the log of the affinity score as: CS=RANK(correlation coefficient)+RANK(−1*sign(correlation coefficient)*LOG(affinity score). Rank for purposes of determining the correlation score is illustratively embodied as a numerical ordering, for example, rank of the correlation coefficients between different pairings could be 20.75, 8.13, -1.21 with ranks of 1, 2, 3, respectively.

In box 48, a portfolio score can be determined. The portfolio score is illustratively embodied as the collective score for the given portfolio of consumer item pairings. In the illustrative embodiment, the target portfolio is defined by the universe of consumer items considered with respect to their promotional response. The portfolio score is illustratively determined as the product of the correlation score percentile multiplied by the root of the product of the incremental traffic percentile of the first consumer item multiplied by the incremental traffic percentile of the second consumer product as:

$$Portfolio Score = correlation score percentile * \sqrt{incremental traffic percentile first * incremental traffic percentile second .}$$

The percentiles for purposes of portfolio score are defined according to the distribution within the target portfolio, for example, correlation scores of 1, 5, and 9 may constitute 99th, 95th, and 91st percentiles, respectively, for a target portfolio having 100 consumer items.

In box 50, a promotional level portfolio score can be determined. The promotional level portfolio score is illustratively embodied as the collective score for the given portfolio of consumer item pairings, similar to the portfolio score, but considers the predicted traffic value. The promotional level portfolio score is illustratively determined as the product of the correlation score percentile multiplied by the root of the product of the incremental traffic percentile of the first consumer item multiplied by the incremental traffic percentile of the second consumer product as:

$$Promotional Level Portfolio Score = correlation score percentile * \sqrt{incremental traffic percentile first * incremental traffic percentile second} * impending incremental traffic value .$$

In box 52, an average of the portfolio score and the promotional level portfolio score is determined as the cross-correlation score.

Referring now to FIG. 8, the correlation score can be determined in consideration of a pair of consumer items. A first promotion illustratively considers items 11 and 12, and a second promotion illustratively considers items 21 and 22. For descriptive ease, in the first promotion, the total incremental traffic attributed to items 11 and 12 is 40, with 24 unit transactions for item 11 and 16 unit transactions for item 12, namely a 60/40 distribution. In the second promotion, the total incremental traffic attributed to items 21 and 22 is 40, with 36 unit transactions for item 21 and 4 unit transactions for item 22, namely a 90/10 distribution. A correlation score for the pair of promotions can be determined as the weighted combination of consumer item correlation scores as the sum of the product of individual weights multiplied by the correlation score for each pair, for example, Correlation Score (Pair)=0.6*0.4*correlation score (11,21)+0.6*0.1*correlation score(11,22)+0.4*0.9*correlation score(12,21)+0.4*0.1*correlation score (12,22).

Consumer communications within the present disclosure can includes methods and/or processes as disclosed, executed on the control system, as mentioned above, via the processor 30 executing instructions stored on memory 32, and communications circuitry 34 for communicating signals to and/or from the control system based on commands of the processor 30 for conducting communication control system operations. Examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry can include components for facilitating processor operations, for example, suitable components may include transmitters, receivers, modulators, demodulators, filters, modems, analog/digital (AD or DA) converters, diodes, switches, operational amplifiers, and/or integrated circuits.

The control system can communicate with external systems and/or devices. For example, other servers or resources (e.g., physical, virtual, cloud, internet, intranet, etc.) may provide consumer activity data for use by the communication control system. The machine learning models are illustratively implemented on the processor, which may include one or more processors, but in some embodiments, may be implemented apart from the processor as a semi-integrated or distinct system of execution in communication with the communication control system. Outputs from the machine learning model can be communication via appropriate hardware, for example, visual communications can be presented via display screen and/or physically printed via printer (e.g., print out of a printed newsletter), and such hardware may be local and/or remote, such as a webserver for populating a webpage with consumer communications (e.g., a digital newsletter).

Within the present disclosure, artificial intelligence (AI) and/or machine learning implementations may include instructions stored on the memory for execution by the processors for disclosed operations. AI and/or machine learning implementations may be embodied as one or more of neural networks, decision tree learning, regression analysis, Gaussian processes, Bayesian optimization and its associated acquisition functions, including any suitable manner of model, for example but without limitation, supervised, quasi-supervised, and/or unsupervised learning models, such as linear regression, logistic regression, decision tree, SVM, Naive Bayes, kNN, k-means, dimensionality reduction algorithms, gradient boosting algorithms (e.g., GBM, LightGBM, CatBoost) style models. Exemplary validation may include consideration of historical data, singular allocation of each subject, etc.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure a rising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

1. A method of consumer communication, the method comprising:
obtaining actual product traffic data concerning consumer products,
applying a mixed model to determine an incremental product traffic value for each consumer product based on the actual product traffic data,
receiving the incremental product traffic values by a machine learning engine as inputs, and predicting, as an output of the machine learning model, impending incremental product traffic based on the incremental product traffic values,
determining a ranking of each consumer product according to an assigned department based on the impending incremental product traffic, and
outputting a ranked list of the consumer products based on the ranking to address the impending incremental product traffic.

2. The method of claim 1, wherein outputting the ranked list includes displaying a list of ranked consumer products.

3. The method of claim 1, wherein outputting the ranked list includes displaying a front-page newsletter comprising a design arrangement based on the ranking.

4. The method of claim 1, wherein the mixed model is a generalized linear model.

5. The method of claim 1, wherein each incremental product traffic value comprises a difference between actual product transactions and an estimated baseline of transactions for each consumer product assuming exclusion from the ranked list.

6. The method of claim 5, wherein the estimated baseline of transactions for each consumer product is determined based on family group.

7. The method of claim 6, wherein family group comprises a grouping of similar consumer product items sharing a brand and designated price point.

8. The method of claim 7, wherein each family group is assigned to a department selected from the group comprising: meat, delicatessen, general merchandizing, produce, and frozen foods.

9. The method of claim 5, wherein the estimated baseline of transactions for each consumer product is determined based on seasonality.

10. The method of claim 9, wherein the estimated baseline of transactions for each consumer product is determined based on seasonality and family group, if promoted during the applicable time period, and based on the effect of family group on seasonality.

11. The method of claim 5, wherein the estimated baseline comprises a simulated number of transactions for each consumer product assuming that the corresponding consumer product is excluded from a front-page newsletter comprising a design arrangement based on the ranking.

12. The method of claim 1, further comprising cross-correlating the consumer products of the ranked list.

13. The method of claim 12, wherein cross-correlating the consumer products of the ranked list includes determining a correlation coefficient between ranked consumer products.

14. The method of claim 13, wherein cross-correlating the consumer products of the ranked list includes indicating one or more ranked consumer products for exclusion from the ranked list based on the correlation coefficients.

15. A consumer communication system comprising:
at least one processor configured to execute instructions stored on memory to:
obtain actual product traffic data concerning consumer products,
apply a mixed model to determine an incremental product traffic value for each consumer product based on the actual product traffic,
receive the incremental product traffic values by a machine learning engine, and predicting impending incremental product traffic based on the incremental product traffic values,
determine a ranking of each consumer product according to an assigned department based on the impending incremental product traffic, and
output a ranked list of the consumer products based on the ranking to address the impending incremental product traffic.

16. The system of claim 15, wherein configuration to output the ranked list includes displaying a list of ranked consumer products.

17. The system of claim 15, wherein configuration to output the ranked list includes displaying a front-page newsletter comprising a design arrangement based on the ranking.

18. The system of claim 15, wherein the mixed model is a generalized linear model.

19. The system of claim 15, wherein each incremental product traffic value comprises a difference between actual product transactions and an estimated baseline of transactions for each consumer product.

20. The system of claim 19, wherein the estimated baseline of transactions for each consumer product is determined based on family group.

21. The system of claim 20, wherein family group comprises a grouping of similar consumer product items sharing a brand and designated price point

22. The system of claim 21, wherein each family group is assigned to a department selected from the group comprising: meat, delicatessen, general merchandizing, produce, and frozen foods.

23. The system of claim 19, wherein the estimated baseline of transactions for each consumer product is determined based on seasonality.

24. The system of claim 23, wherein the estimated baseline of transactions for each consumer product is determined based on seasonality and family group, if promoted during the applicable time period, and based on the effect of family group on seasonality.

25. The system of claim 19, wherein the estimated baseline comprises a simulated number of transactions for each consumer product assuming that the corresponding consumer product is excluded from a front-page newsletter comprising a design arrangement based on the ranking.

26. The system of claim 15, the at least one processor is further configured to execute instructions stored on memory to cross-correlate the consumer products of the ranked list.

27. The system of claim 26, wherein configuration to cross-correlate the consumer products of the ranked list includes determining a correlation coefficient between ranked consumer products.

28. The method of claim 27, wherein configuration to cross-correlate the consumer products of the ranked list includes indicating one or more ranked consumer products for exclusion from the ranked list based on the correlation coefficients.
